(19) United States
(12) Patent Application Publication
(10) Pub. No.: US 2025/0369554 A1
(43) Pub. Date: Dec. 4, 2025

(54) METHOD OF COATING A PIPE

(71) Applicant: George Brownlow, Johannesburg (ZA)

(72) Inventor: George Brownlow, Johannesburg (ZA)

(21) Appl. No.: 18/873,997

(22) PCT Filed: Jun. 19, 2023
(86) PCT No.: PCT/ZA2023/050031

§ 371 Date: Dec. 11, 2024

(30) Foreign Application Priority Data
Jul. 12, 2022 (ZA) 2022/06449

(51) Int. Cl. F16L 58/10; B05C 5/02

(52) U.S. Cl. CPC F16L 58/109; B05C 5/0254

(57) ABSTRACT

The invention provides a method of applying a corrosion resistant coat to a pipe section by extruding a viscoelastic material, from an extruder, onto an exterior surface of the pipe section, while simultaneously imparting rotational and longitudinal movement to the pipe section, and while adjusting at least one process parameter to ensure that a thickness of the corrosion resistant coat is within a range 500 μm to 2000 μm.

### FIELD OF THE INVENTION

The invention relates to a method of coating a metallic pipe for corrosion resistance.

### SUMMARY OF THE INVENTION

Underground pipelines are commonly utilized for the transportation of water, sewerage, oil, gas, or petroleum products, or the like. These pipelines are made of a plurality of sections, typically measuring approximately 19 meters in length, with diameters ranging from around 100 mm to 1500 mm, averaging 900 mm. The pipe sections can be constructed from various materials, including metals, such as steel, as well as concrete, plastic/polymer, or a composite material.

Steel pipes are often preferred due to the mechanical versatility of the material across a wide range of applications. Polymer pipes of typical wall thickness do not have the hoop strength, tensile strength and/or yield strength to convey fluids under high pressure. To adapt such pipes to convey high pressure fluids, the wall thickness must increase, significantly increasing cost. In comparison to this alternative, steel pipes remain cost effective. Yet steel is prone to rust. Therefore, it is necessary to apply corrosion protection to the pipe sections to increase the lifespan of the pipeline, to maintain the cost benefit justification.

Conventional methods for applying a corrosion-resistant coating to a pipe section involve a complex, costly, multi-step process, including the following steps: 1) preheating the pipe section, 2) blast cleaning an outer surface of the pipe section, 3) surface grinding the outer surface, 4) inspecting the outer surface, 5) heating the pipe to between 180° C. and 250° C., 6) applying a primary coat of a Fusion Bonded Epoxy (FBE) to the outer surface, 7) extruding an adhesive copolymer over the FBE, 8) extruding a mechanical coat of a polyolefin, such as polypropylene (PP), over the adhesive layer, 9) cooling the pipe by quenching, and 10) inspecting the pipe section for discontinuities in the coats with an electrical conductivity test.

As evident, extensive pre-coating preparation is necessary to ensure a clean outer surface, free from any film or scale, with a precise surface profile conforming to standard SA 2.5 to 3. These measures are crucial to ensure proper adherence of the primary and first coat to the outer surface.

Furthermore, the application of the FBE primer (primary coating) requires the pipe section to be heated to high temperatures, resulting in an energy-intensive step. Subsequently, a quenching process is necessary due to the elevated temperatures involved.

This conventional three-layer system requires the presence of the adhesive layer to bind the outer mechanical layer to the FBE primer.

In another energy-intensive step, in the extrusion of the adhesive copolymer onto the outer surface using a second extruder, alongside a main extruder, a substantial amount of heat input is required to enhance the copolymer's pliability. This parameter is another critical aspect that necessitates meticulous control of the extrusion process to achieve optimal film thickness.

The present invention at least partially addresses the aforementioned problem.

### SUMMARY OF INVENTION

“Mechanically resistant” when used to describe a coat, means the coat, and the material it is comprised of, is resistant to fatigue (progressive and localized structural damage that occurs when a material is subjected to repeated cyclic loading or stress), stress, heat, cathodic disbondment and oxidation.

The invention provides a novel method for effectively applying a corrosion-resistant coat to a pipe section.

The invention provides a method of applying a corrosion resistant coat to a pipe section by extruding a viscoelastic material, from an extruder. onto an exterior surface of the pipe section, while simultaneously imparting rotational and longitudinal movement to the pipe section, and while adjusting at least one process parameter to ensure that a thickness of the corrosion resistant coat is within a range 500 μm to 2000 μm.

Preferably, the thickness of the corrosion resistant coat is within a range 900 μum to 1100 μm.

More preferably, the thickness of the corrosion resistant coat is 1000 μm.

The at least one process parameter may be the temperature of the viscoelastic material, the viscosity of the viscoelastic material, the force/pressure applied to the viscoelastic material in extruding the material from the extruder, the temperature within the extruder, the flow rate of the viscoelastic material as it leaves the extruder, the angular velocity of the rotational movement of the pipe section, the longitudinal velocity of the longitudinal movement of the pipe section, the distance of an outlet slot of the extruder from the pipe section, the angular orientation of the outlet slot relatively to the pipe section and the width or area of the outlet slot (hereinafter referred to as “the process parameters”).

The temperature of the viscoelastic material may be adjusted to keep within a range of 30° C. to 100° C.

The corrosion resistant coat may be applied directly to the exterior surface of the pipe section, i.e., without the need to apply a primary coat or primer.

Preferably, the viscoelastic material is poly-isobutylene (PIB).

Alternatively, the viscoelastic material may be a mixture of PIB and butyl rubber.

The pipe section may be a metallic pipe section. Preferably the metallic pipe section is a steel pipe section.

The method may include the additional step of applying a mechanically resistant coat over the corrosion resistant coat.

The step of applying the mechanically resistant coat may be done simultaneously with the step of applying the corrosion resistant coat. This simultaneous application may be achieved by co-extrusion, preferably inline co-extrusion.

Alternatively, the step of applying the mechanical resistant coat may be done after the step of applying the corrosion resistant coat.

The mechanical coat may be a coat of a thermoplastic material, such as a polyolefin. The polyolefin may be a medium-or high-density polyethylene, polypropylene.

Alternatively, the mechanical coat may be an elastomeric poly-urea material, or a thermoset glass reinforced epoxy (GRE).

The thermoplastic material may be applied by extrusion.

The GRE material may be applied by any suitable method, for example, spraying or by rotation of a flexible sheet of GRE onto the pipe section.

The elastomeric poly-urea material may be applied by spray coating.

The viscoelastic material and the thermoplastic material may be extruded by passing the respective material through a slot-die. The slot-die may be a lipped slot-die.

The method may include the additional, preferable, preceding step of abrading the exterior surface of the pipe section by brushing or blasting to remove mill scale.

The method may include the additional step of scraping an excess of the viscoelastic material from the corrosion resistant coat to ensure that the corrosion resistant coat has a chosen thickness within a range 500 μm to 2000 μm, preferably 900 μm to 1100 μm, more preferably 1000 μmm.

Another aspect of the invention provides a method of extruding a corrosion resistant coat of a viscoelastic material from an extruder onto an exterior surface of the pipe section, while imparting rotational and longitudinal movement to the pipe section, to ensure that a thickness of the corrosion resistant coat is of a desired thickness, the method including the steps of:
a) entering a dataset into a processor, running a program, that includes a measurement of the thickness of the corrosion resistant coat and information on one or more of the process parameters associated with the measured thickness;
b) entering data into the processor from at least one sensor or meter which is adapted to measure one or more of the process parameters;
c) obtaining from the processor, based on the dataset and the data, an estimated thickness of the corrosion resistant coat; and
d) based on the estimated thickness, changing one or more of the parameters to achieve the desired thickness.

The program may include an artificial intelligence algorithm.

### BRIEF DESCRIPTION OF THE DRAWINGS

An embodiment of the invention is now described by way of a non-limiting example only with reference to the drawings in which:

FIG. 1 schematically illustrates a process of applying a corrosion resistant layer to a pipe in accordance with the prior art;

FIG. 2 schematically illustrates a process of applying a corrosion resistant coat to a pipe which includes a method in accordance with the invention;

FIG. 3 is a view in horizontal section through a slot-die extruder employed in the method of the invention;

FIG. 4 is a view in cross section taken through line 4-4 on FIG. 3;

FIG. 5 schematically illustrates an extrusion step in the method of the invention;

FIG. 6 schematically illustrates in greater detail the slot-die in the extrusion step;

FIG. 7 is an isometric view of a pipe section being coated with the corrosion resistant pipe in accordance with the method of the invention;

FIG. 8 is a flow diagram of a computerised system employed in the method of the invention.

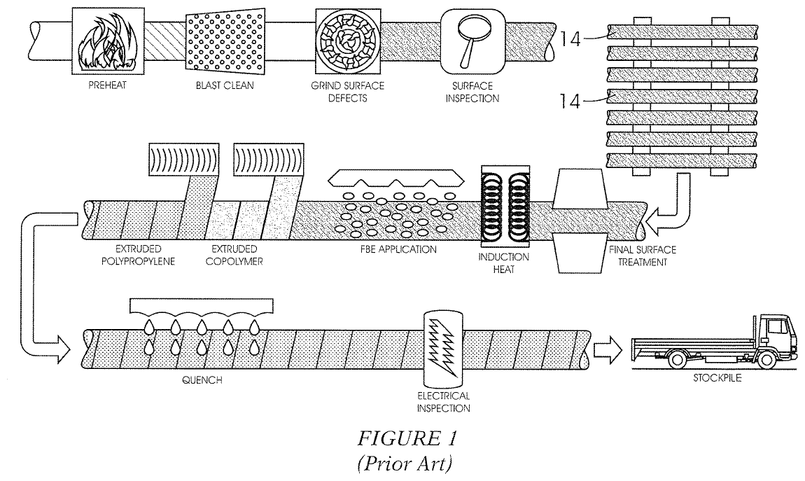

### DETAILED DESCRIPTION OF PREFERRED EMBODIMENT

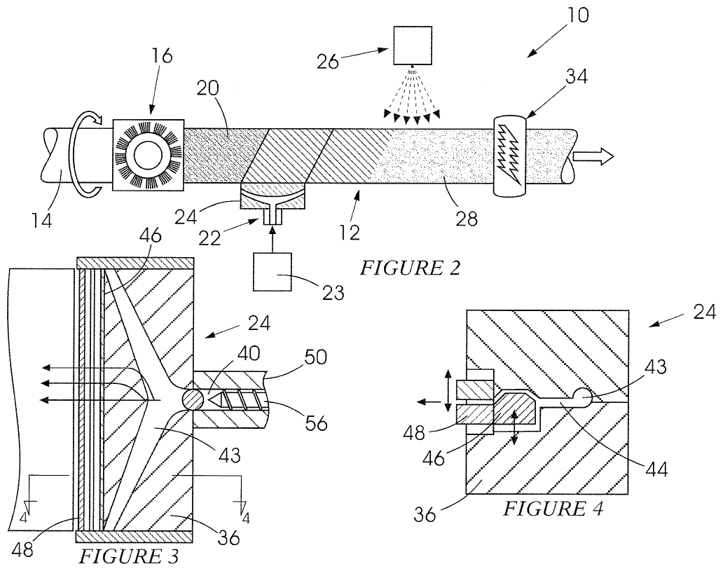

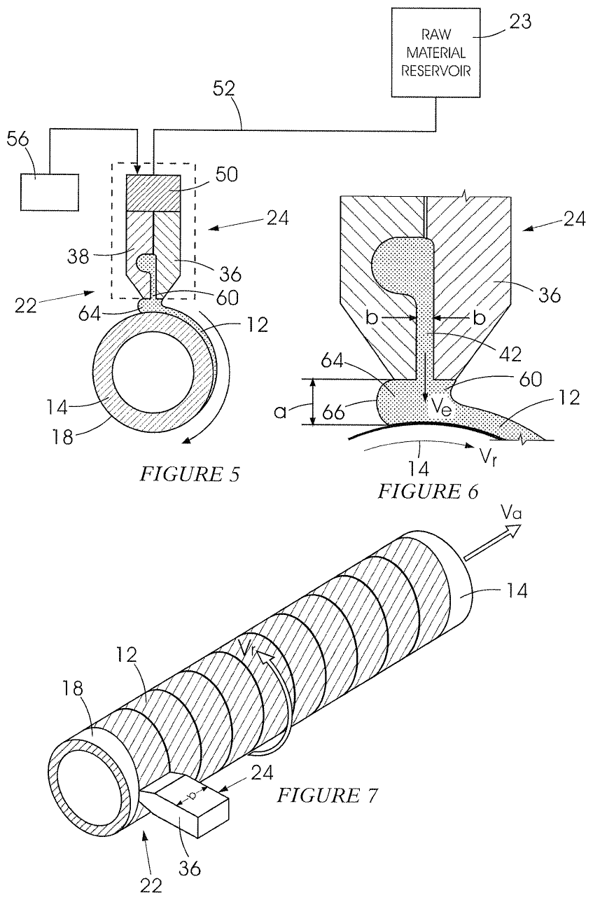

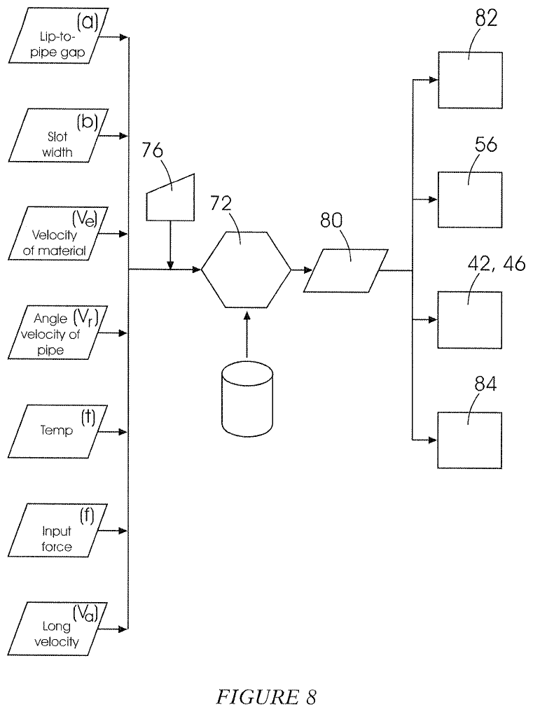

FIG. 2 illustrates a method 10 for applying a corrosion resistant coat 12 to a pipe section 14. The pipe section can be used in any environment, including an on shore, offshore or submerged environment, where exposure to corrosive elements is a problem.

The pipe section 14 in this example is a section of steel pipe, typically 19 meters in length and with a diameter of approximately 900 mm.

In applying the corrosion resistant coat 12, the pipe section 14 is caused to move in a longitudinal direction (see directional arrow designated Vₐ on FIG. 7) and in a rotational direction (see directional arrow designated Vᵣ on FIG. 7).

In a first process step 16, an outer surface 18 of the pipe section is mechanically abraded by any suitable method such as, for example, wire brushing, shot blasting or the like. This process only requires the mill scale to be removed. No profile is required and therefore no testing for an optimal profile is required and the shot material can be a standard conventional blast material. The abrasion of the outer surface will cause this surface to be pitted, providing a rough, abraded surface profile 20 onto which the coating material to be applied in a preceding step adheres. This step is a preferred step, but it is not essential to the method. This step cleans the surface of any oily residue and removes any moisture.

In a second process step 22, the corrosion resistant coat 12 of poly-isobutylene (PIB), from a source 23, is applied to the outer surface 18 of the pipe section 14 by extrusion through a slot-die extruder 24.

In a third process step 26, a mechanically resistant coat 28 is applied over the corrosion resistant coat.

The mechanically resistant coat can be a coat of a thermoplastic material, such as for example, medium-and high-density polyethylene, poly-urea, polypropylene, or an elastomeric material, or a thermoset such as a glass reinforced epoxy (GRE) material. The choice of material for this coat will depend upon considerations of cost, environment and, ultimately, function.

If the mechanical resistant coating is medium-density polyethylene, high-density polyethylene or polypropylene 30, then the coating can be applied to the outer surface 18 by extrusion, through a second slot-die extruder. Other application methods are used if GRE rotational coating, or an elastomeric poly-urea material (applied by spraying) is chosen as the appropriate material for the mechanical resistant coating. It is important to note that the mechanically resistant coating is applied wet directly over the PIB coat.

The mechanical coating is applied as a standard coat over the corrosion protection layers in all pipelines. Typical reasons for this coat include protection during transport and stacking, and compliance with the engineer's requirements of an extra mechanically resistant coat. This coat is important as PIB, exhibiting many favourable properties (listed below), is a soft, compliant material. The pipe sections typically range between 2 to 5 tonnes, and during storage and transportation, locations along the pipe section are prone to high point load which could damage this coat.

In this example, the corrosion resistant coat and the mechanical coat are applied in separate process steps. However, it is contemplated within the scope of the invention that both coats can be applied simultaneously through, for example, a co-extrusion process.

Finally, the pipe section is inspected to ensure that there are no discontinuities/holes in the corrosion resistant coat. This is done by employing a Holiday detection step 34. If the pipe section 14 passes the test, it can be stacked and stored ready for deployment within a pipeline (not shown).

In describing the invention further, and for ease of explanation, the application of the mechanical coating 28 is not described further.

FIGS. 3 and 4 illustrate a slot-die head 36 of the slot-die extruder 24. This component is an essential part of the disposition technique provided by the extruder. The slot-die head includes a body 38, an inlet 40, a slot 42 (see FIG. 6), which slot is comprised of a manifold 43 and a land 44, optionally a choker bar 46 (which is actuable to alter flow rate of the PIB through the slot), and lips 48. In addition to the slot-head, the extruder 32 includes a throat 50.

The inlet 40 terminates a supply conduit 52 which delivers PIB from the PIB source 23 to the extruder. The PIB is delivered at ambient room temperature (+/−25° C.) temperature. An auger pump 56, or any alternative pressurising means such as non-stick quick rotation back rollers (not shown), can be employed to apply pressure to the PIB delivery stream to force the delivery stream of PIB paste or putty into the throat 50. With the PIB paste pressurised as it flows through the extruder, it will heat due to fictional engagement with the extruder thereby increasing its fluidity. It is not however anticipated that the temperature will exceed 50° C.

Within the throat, the extruder may include heating elements (not shown). These heating elements supply can be energised to supply heat 58 to the PIB when the ambient temperature falls below 23° C., changing the viscosity of the PIB to a more fluid state.

A fluid stream 60 of PIB is extruded from the slot-die head 36, through the slot 42, exiting the head at the lips 48. Between the lips and the outer surface 18 of the pipe section 14 (a gap 62), the PIB constitutes a coating bead 64 (see FIG. 6) which forms between an upstream meniscus 66 and a downstream meniscus 68, before the bead flows out to provide the corrosion resistant coat 12.

To provide a corrosion resistant PIB coat 12 which is uniformly applied to the pipe section's outer surface in terms of thickness and unbroken surface coverage, the stability of the configuration of the coating bead 64 must be maintained. This stability is dependent upon the following variable parameters—the distance (a) of a lip-to-pipe gap, the width (b) of the slot 42, the viscosity (μ) of the PIB, the temperature (t) within the extruder 24, the output flow rate (Vₑ) of the PIB stream, the orientation of the lips 48 relatively to the pipe, the angular velocity (Vᵣ) of the pipe section's rotation, the longitudinal velocity (Vₐ) of the pipe section and the input force (f) applied by the pressurising means, for example the auger pump 56, on the PIB stream.

The benefit of extruding PIB is that it requires no heat input when extruded, thereby improving the stability of the configuration of the coating bead 64 if the ambient temperature remains at 23° C. or above. Even though PIB is extruded at this relatively low temperature, it is sufficiently fluid to form a coat on the pipe of uniform thickness of 1000 μm.

This preferred thickness was found by the applicant to be optimal. Any thicker and the cost to benefit ratio increases and any thinner and the corrosion resistant efficacy of the layer significantly decreases.

To control the quality of the corrosion resistant coat 12, a computerised control system is provided. The input values of each of these parameters (respectively a, b, μ, t, f, Vₑ Vᵣ Vₐ) as measured by a relevant sensor or meter (not shown) is feed in real time to a processor 72. Manual input 76 of the desired thickness of the coat 12 is provided. Running relevant software, firmware, or an AI algorithm, and drawing on historical data from a database 78, the processor will provide an output 80 of remedial action to take to achieve the desired coat thickness based on the real-time data streams.

The remedial actions can be automated or manually effected.

Remedial action may take one or more of: energising the heating elements to heat the PIB, adjusting the distance of the gap 62 or orientation of the lips 48 (hereinafter the die-head positioning system 82), adjusting the force applied by the auger pump 56, adjusting the slot 42 width (by actuation of the choker bar 46), and adjusting the angular and forward velocity of the pipe section (hereinafter pipe movement system 84).

The benefits of using poly-isobutylene (PIB) in the corrosion resistant layer is that this material does not delaminate or dis-bond from the surface of the pipe section, it is able to “self-heal” to close any hole and it adheres at a molecular level and at ambient temperature to the surface.

1. A method of applying a corrosion resistant coat to a pipe section by extruding a viscoelastic material, from an extruder, onto an exterior surface of the pipe section, while imparting rotational and longitudinal movement to the pipe section, and while adjusting at least one process parameter to ensure that a thickness of the corrosion resistant coat is within a range 500 μm to 2000 μm.

2. A method of applying a corrosion resistant coat to a pipe section according to claim 1 wherein the thickness of the corrosion resistant coat is within a range 900 μm to 1100 μm.

3. A method of applying a corrosion resistant coat to a pipe section according to claim 2 wherein the thickness of the corrosion resistant coat is 1000 μm.

4. A method of applying a corrosion resistant coat to a pipe section according to claim 1 wherein the at least one process parameter is one of the following: the temperature of the viscoelastic material, the viscosity of the viscoelastic material, the force or pressure applied to the viscoelastic material in extruding the material from the extruder, the temperature within the extruder, the flow rate of the viscoelastic material as it leaves the extruder, the angular velocity of the rotational movement of the pipe section, the longitudinal velocity of the longitudinal movement of the pipe section, the distance of an outlet slot of the extruder from the pipe section, the angular orientation of the outlet slot relatively to the pipe section and the width or area of the outlet slot.

5. A method of applying a corrosion resistant coat to a pipe section according to claim 4 wherein the temperature of the viscoelastic material is adjusted to keep within a range of 30° C. to 100° C.

6. A method of applying a corrosion resistant coat to a pipe section according to claim 1 wherein the corrosion resistant coat is applied directly to the exterior surface of the pipe section.

7. A method of applying a corrosion resistant coat to a pipe section according to claim 1 wherein the viscoelastic material is poly-isobutylene (PIB), or a mixture of PIB and a butyl compound.

8. A method of applying a corrosion resistant coat to a pipe section according to claim 1 which includes the step of applying a mechanically resistant coat over the corrosion resistant coat.

9. A method of applying a corrosion resistant coat to a pipe section according to claim 8 wherein the mechanically resistant coat is applied simultaneously with the application of the corrosion resistant coat.

10. A method of applying a corrosion resistant coat to a pipe section according to claim 9 wherein the mechanically and the corrosion resistant coat are applied simultaneously by co-extrusion or inline extrusion.

11. A method of applying a corrosion resistant coat to a pipe section according to claim 8 wherein the mechanically resistant coat is applied after the application of the corrosion resistant coat.

12. A method of applying a corrosion resistant coat to a pipe section according to claim 8 wherein the mechanically resistant coat includes one or more of the following: a polyolefin, an elastomeric poly-urea, and a thermoset glass reinforced epoxy (GRE).

13. A method of applying a corrosion resistant coat to a pipe section according to claim 12 wherein the polyolefin is applied by extrusion.

14. A method of applying a corrosion resistant coat to a pipe section according to claim 12 wherein the GRE is applied by spraying or by rotation of a flexible sheet of GRE onto the pipe section.

15. A method of applying a corrosion resistant coat to a pipe section according to claim 12 wherein the elastomeric poly-urea material is applied by spray coating.

16. A method of applying a corrosion resistant coat to a pipe section according to claim 1 wherein the viscoelastic material and the thermoplastic (polyolefin) material is extruded by passing the respective material through a slot-die.

17. A method of applying a corrosion resistant coat to a pipe section according to claim 16 wherein the slot-die is a lipped slot-die.

18. A method of applying a corrosion resistant coat to a pipe section according to claim 1 which includes the step of abrading the exterior surface of the pipe section by brushing or blasting to remove mill scale prior to extruding the viscoelastic material.

19. A method of applying a corrosion resistant coat to a pipe section according to claim 1 which includes the additional step of scaping an excess of the viscoelastic material from the corrosion resistant coat to ensure that the coat has a chosen thickness within the range 500 μm to 2000 μm.
